(19) United States
(12) Patent Application Publication
(10) Pub. No.: US 2004/0181412 A1
(43) Pub. Date: Sep. 16, 2004

(54) Medical imaging analysis using speech synthesis

(76) Inventor: Wido Menhardt, Los Gatos, CA (US)

Correspondence Address: Pamela R. Crocker, Patent Legal Staff, Eastman Kodak Company, 343 State Street, Rochester, NY, 14650-2201, US

(21) Appl. No.: 10/778,559

(22) Filed: Feb. 13, 2004

Related U.S. Application Data
(60) Provisional application No. 60/451,376, filed on Feb. 26, 2003.

(51) Int. Cl. G10L 11/00

(52) U.S. Cl. 704/270

(57) ABSTRACT

A system and method for examining a medical image. To accomplish the method, a digital image is accessed wherein the digital image is representative of the medical image. The digital image is analyzed using Computer Aided Detection (CAD) to detect candidate abnormalities. A CAD report is generated comprising at least one level of information associated with the detected candidate abnormalities. The CAD report is processed to produce a speech synthesized CAD report in accordance with the at least one level of information. The digital image is simultaneously displayed with the delivery of the speech synthesized CAD report whereby the user can examine the digital image while simultaneously listening to the CAD report.

### CROSS REFERENCE TO RELATED APPLICATIONS

This is a 111A application of Provisional Application Serial No. 60/451,376 filed Feb. 26, 2003.

### FIELD OF THE INVENTION

This invention generally relates to computer aided detection (CAD) of abnormalities in medical images and, in particular, to a system and method for analyzing a medical image using speech synthesis, such as a synthesized CAD report.

### BACKGROUND OF THE INVENTION

Analysis of medical images such as mammograms can be processed by Computer Aided Detection (CAD) methods to help a radiologist in the detection of abnormalities within regions of interest (ROI). CAD analysis requires a digitized image, which is analyzed using appropriate CAD applications. In the case of mammography, such applications can, for example, identify regions exhibiting microcalcifications. Typically, regions/areas of interest, such as abnormalities, are indicated on the digital image in such a way as to attract the attention of the radiologist. The results can either be used directly to formulate a diagnosis, or be compared to the results obtained by the radiologist using a direct observation of the original image.

The CAD results can also be presented in a written report such that the radiologist can read the report and then compare the results of the CAD results with his/her direct observations of the image. These actions are performed sequentially, thereby forcing the radiologist to go back and forth between the CAD results and the image. This can lead to inefficiencies and could increase the likelihood of errors in comparing the results.

There therefore exists a need for a method that would overcome these disadvantages.

### SUMMARY OF THE INVENTION

An object of the present invention is to provide a method and a system for examining medical images for diagnosis purposes with improved efficiency.

Another object of the present invention is to provide such a method and system which can achieved simultaneously display an image and activate a speech synthesized Computer Aided Detection (CAD) report based on CAD analysis of the image.

A further object of the present invention is to provide such a method and system wherein a CAD report comprising one or more levels of information characterizing abnormalities within the image detected by the CAD analysis is generated and translated into a speech synthesized report.

Yet another object of the present invention is to provide such a method and system wherein the speech synthesized report can be interactively modified by a user to include desired levels of information.

These objects are given only by way of illustrative example, and such objects may be exemplary of one or more embodiments of the invention.

Other desirable objectives and advantages inherently achieved by the disclosed invention may occur or become apparent to those skilled in the art. The invention is defined by the appended claims.

According to one aspect of the invention, there is provided a method for examining a medical image. The method comprises the steps of: accessing a digital image representative of the medical image; analyzing the digital image using Computer Aided Detection (CAD) to detect candidate abnormalities; generating a CAD report comprising at least one level of information associated with the detected candidate abnormalities; processing the CAD report to produce a speech synthesized CAD report in accordance with the at least one level of information; and simultaneously displaying the digital image and delivering the speech synthesized CAD report whereby the user can examine the digital image while simultaneously listening to the CAD report.

According to another aspect of the invention, there is provided a method for assigning a Computer Aided Detection (CAD) application to a digital image for which a speech synthesized CAD report is associated. The method comprises steps of: selecting an acquisition model from a plurality of acquisition models based on one or more attributes of the digital image and on a desired content of the associated speech synthesized CAD report; and determining a CAD application from a plurality of CAD applications based on the selected acquisition model.

According to yet another aspect of the invention, there is provided a system for producing a speech synthesized Computer Aided Detection (CAD) report of a medical image. The system comprises means for accessing a digital image representative of the medical image; a digital storage device for storing the digital image; a CAD analyzer comprising at least one CAD algorithm adapted to analyze the stored digital image; a CAD report generator for producing a CAD report based on a CAD analysis performed by the CAD analyzer; a speech synthesizer adapted to translate the CAD report into a speech synthesized CAD report and deliver the speech synthesized CAD report to a user; an interface adapted to communicate with the CAD report generator, the speech synthesizer, and the digital storage device; and a display for displaying the stored digital images to the user simultaneous with the delivery of the speech synthesized CAD report.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a flow chart diagram of an embodiment of the method in accordance with the present invention describing the generation of a speech synthesized CAD report and its simultaneous activation together with the displaying of the medical image.

FIG. 2 shows a flow chart diagram of an embodiment of the system in accordance with the present invention.

FIG. 3 shows a schematic representation/flow chart diagram of an example of a CAD report exhibiting several levels of information and the request for additional levels of information by a user.

### DETAILED DESCRIPTION OF THE INVENTION

The following is a detailed description of the preferred embodiments of the invention, reference being made to the drawings in which the same reference numerals identify the same elements of structure in each of the several figures.

Generally, the present invention provides a method for producing a speech synthesized report of Computer Aided Detection (CAD) results obtained from the analysis of digitized medical images, for example, digital mammograms or digitized x-ray films.

Once the digitized medical images have been obtained and stored, analysis by a CAD application is initiated. Once initiated, the CAD application first performs a series of image processing steps to detect potentially suspicious or candidate regions (such as those regions exhibiting probable abnormalities). This detection can be achieved for example by using spatial bandpass filters of different sizes to detect the presence of masses or by using high pass filters to highlight bright but small areas of the image indicative of the presence of calcifications. Other detection methods may be known to those skilled in the art.

After detecting the suspicious regions, a series of features are extracted for each region and are used to determine the likelihood that the identified region is characteristic of a disease such as cancer.

U.S. Pat. No. 6,246,782, issued Jun. 12, 2001, inventors Shapiro et al., which is incorporated herein by reference, describes a system for automated detection of cancerous masses in mammograms. The features extracted from suspicious regions may include size, brightness, location, density, number and length of spicules and the like. These features can be analyzed by several different methodologies that are known in the art. For example, Shapiro describes the use of such features as inputs for neural networks that are trained based on a set of data using images containing certain cancerous and non-cancerous features. The system thus “learns” which features and combinations of features are indicative of a potential cancer.

In one embodiment of the invention, the CAD results are processed to be included in a speech synthesized CAD report which can be activated simultaneously with the display of the corresponding digitized image. A radiologist may then listen to the report while examining the image thereby avoiding/reducing the necessity of going back and forth between the image and a written (or displayed) CAD report.

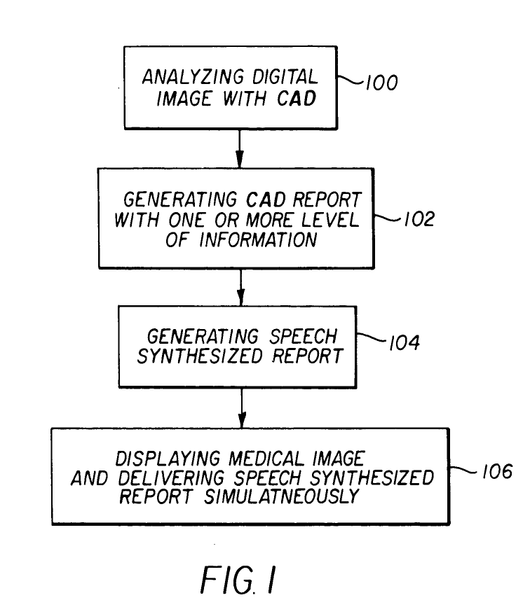

This method is more particularly described with reference to FIG. 1. As shown in FIG. 1, at step 100, the digital image is analyzed using CAD. The CAD report is then generated with one or more levels of information (step 102). The speech synthesized report can then be generated (step 104). Then, at step 106, the medical image can be displayed simultaneously with the delivery (oral) of the speech synthesized report.

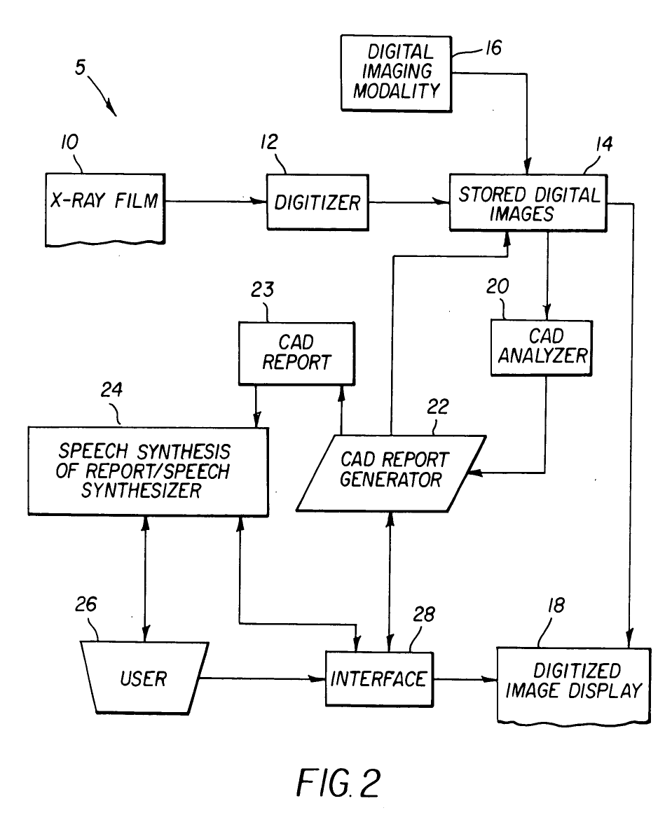

An example of a system 5 used to carry out the embodiments of the method of the present invention is described using the diagram shown in FIG. 2. First, a digital image is accessed. Such access can be accomplished by an x-ray film 10 being digitized by a film digitizer 12 to generate the digital image. Alternatively, the digital image can be obtained using a digital imaging modality 16, for example, known methods such as computed radiography (CR), digital radiography (DR), or digital mammography. As is well known, the digital image can be stored in a digital storage device 14, such as a computer or database.

The digital image can be displayed using an image display/monitor 18 and/or processed by a CAD analyzer 20 which comprises one or more CAD algorithms.

A CAD report 23 is then prepared by a CAD report generator 22 to provide desired information, as will be further described below. CAD report generator 22 can be in communication with digital image storage device 14 so as to share/transfer data. Images can be processed to display selected information from the CAD analysis on the image.

CAD report 23 generated by CAD report generator 22 is translated into sentences that are speech synthesized by a speech synthesizer 24 to generate a synthesized CAD report. Such translation devices are known. Once translated, a voice output can be produced and orally deliver the synthesized CAD report to a user 26. CAD report 23 is preferably translated into sentences that are normally used by physicians to communicate between them when discussing and characterizing a medical image for diagnosis purposes. The speech synthesized CAD report can be delivered to the user by means of speakers, headphones, headsets, or the like. Alternatively, the speech synthesized CAD report can be delivered as a voice output to a voice output to a voice recording device such as a tape recorder, a telephone voice-mail or the like to be retrieved and listened to by the user.

User 26 can communicate with speech synthesizer 24, CAD report generator 22, and store device 14 through an interface 28. Interface 28 can include a keyboard, mouse, touchscreen, data pen, voice recognition, or other interface device as would be well-known to those skilled in the art. In particular, interface 28 can comprise one or more microphones to allow the user to utilize speech commands to communicate with the system.

CAD report 23 generated by CAD report generator 22 preferably comprises information related to the identification and characterization of abnormalities within an image, as for example the location and the nature of detected abnormalities. CAD report 23 can also comprise other information such as the characteristics of the abnormality relied on by the CAD algorithm to determine the nature of the abnormality.

According to one aspect of the method of the present invention, the system of the invention advantageously allows desired information from CAD analyzer 20 to be incorporated in the speech synthesized CAD report. Preferably, the information contained in the CAD report is divided into different levels and one or more desired levels may be interested in the speech synthesized report.

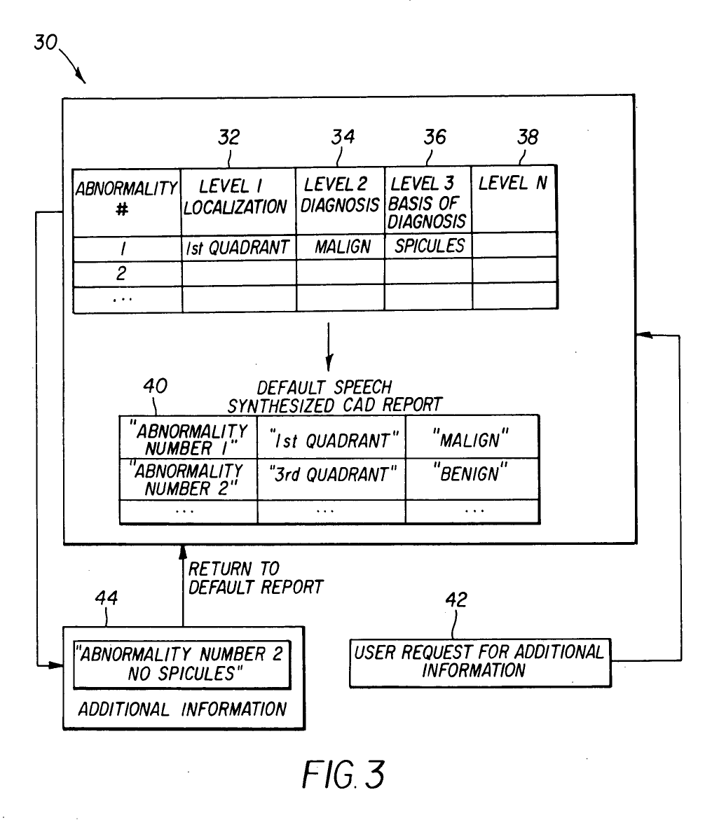

Referring now to FIG. 3 there is shown a diagram representative of an exemplary CAD report 30 having different levels of information. For the example shown in FIG. 3, information level one (1) (shown at 32) provides the localization of the abnormality, level two (2) (shown at 34) provides the diagnosis according to the CAD analysis and level three (3) (shown at 36) provides the basis of the CAD analysis. It can be appreciated that other levels (shown at 38 by Level N) can be included. The other/additional levels may be desirable depending on, for example, the type of organ being analyzed, the type of CAD application, and the like.

System 5 preferably provides a default CAD report format incorporating pre-determined levels of information. Thus, for example, a speech synthesized report may include localization and CAD-based diagnosis (Levels 1 and 2 in the example shown in FIG. 3).

A default speech synthesized report can be configured to voice the identity of the abnormality, for example, “abnormality number 1” and then voice the localization “first quadrant” and finally the CAD-based diagnosis “malign”, as noted in FIG. 3 at 40. This arrangement can be repeated for each abnormality identified by CAD analyzer 20 and CAD report generator 22.

In addition to providing a default report, system 5 of the present invention can be configured to allow a user to stop the speech synthesized report when it is describing a given abnormality and request additional information on the particular abnormality by calling one or more higher levels of information. This is illustrated in FIG. 3 at 42. This can be achieved by allowing the user to communicate with the speech synthesizer to control the flow of the CAD report and with the CAD report generator to specify what additional level of information is required.

For example, the user may decide, after hearing the default information on a particular abnormality (for example, abnormality number 2), that additional information is required for the user to determine whether the CAD-based diagnosis is valid. The user could, at that point, request an additional level of information through user interface 28. Once the additional information is provided for a particular abnormality, the speech synthesized report can resume the default CAD speech synthesized report. This is illustrated in FIG. 3 at 44. The delivery of the speech synthesized report can therefore be interactively modified to best suit the information needs of the radiologist.

It can be appreciated that the CAD application used to analyze the image may depend on the type of information desired in the CAD report and, ultimately, the speech synthesized report. Accordingly, in a preferred embodiment of the method of the present invention there is provided a process comprising the selection of an acquisition model from a plurality of acquisition models based on one or more attributes of the digital image and on a desired content of the speech synthesized CAD report. The selected acquisition model can then be used to determine an appropriate CAD application selected from a plurality of CAD applications.

Activation of the CAD report can be initiated by different means. For example, the CAD report can be activated by entering a bar code number or other identifier, scanning a bar code, selecting a particular report from a plurality of reports using a mouse, a touch screen, or the like, or by other means known to persons skilled in the art.

The embodiment(s) of the invention described above is (are) intended to be exemplary only. The scope of the invention is therefore intended to be limited solely by the scope of the appended claims.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

5 system

10 x-ray film

12 film digitizer

14 storage device for storing a digital image

16 digital imaging modality

18 digitized image display

20 CAD analyzer

22 CAD report generator

23 CAD report

24 speech synthesizer

26 user

28 interface

What is claimed is:

1. A method for examining a medical image, comprising the steps of:
accessing a digital image representative of the medical image;
analyzing the digital image using Computer Aided Detection (CAD) to detect candidate abnormalities;
generating a CAD report comprising at least one level of information associated with the detected candidate abnormalities;
processing the CAD report to produce a speech synthesized CAD report in accordance with the at least one level of information; and
simultaneously displaying the digital image and delivering the speech synthesized CAD report whereby the user can examine the digital image while simultaneously listening to the CAD report.

2. The method of claim 1 wherein the CAD report comprises more than one level of information and the speech synthesized CAD report comprises one or more selected levels thereby defining a default speech synthesized CAD report.

3. The method of claim 2 further comprising the step of:
requesting one or more additional levels of information from the CAD report for inclusion in the speech synthesized CAD report.

4. The method of claim 3 wherein the step of requesting is performed simultaneously with the delivery of the default speech synthesized report.

5. The method of claim 4 wherein the step of requesting is performed for the additional levels of information on one or more selected detected abnormalities.

6. The method of claim 5 wherein the speech synthesized CAD report returns to the default speech synthesized CAD report after the one or more selected additional levels of information has been delivered.

7. The method of claim 1 wherein the at least one level of information comprises information related to at least one of the following: localization, diagnosis, or basis of diagnosis of the detected abnormalities.

8. A method for assigning a Computer Aided Detection (CAD) application to a digital image for which a speech synthesized CAD report is associated, the method comprising steps of:
selecting an acquisition model from a plurality of acquisition models based on one or more attributes of the digital image and on a desired content of the associated speech synthesized CAD report; and
determining a CAD application from a plurality of CAD applications based on the selected acquisition model.

9. A system for producing a speech synthesized Computer Aided Detection (CAD) report of a medical image, comprising:
means for accessing a digital image representative of the medical image;
a digital storage device for storing the digital image;
a CAD analyzer comprising at least one CAD algorithm adapted to analyze the stored digital image;
a CAD report generator for producing a CAD report based on a CAD analysis performed by the CAD analyzer;
a speech synthesizer adapted to translate the CAD report into a speech synthesized CAD report and deliver the speech synthesized CAD report to a user;
an interface adapted to communicate with the CAD report generator, the speech synthesizer, and the digital storage device; and
a display for displaying the stored digital images to the user simultaneous with the delivery of the speech synthesized CAD report.

10. A computer storage medium having instructions stored therein for causing a computer to perform the method of claim 1.
